(19) United States
(12) Patent Application Publication
(10) Pub. No.: US 2009/0119207 A1
(43) Pub. Date: May 7, 2009

(54) POINT OF SALE PAYMENT SYSTEM FOR MULTIPLE RECIPIENTS USING A DIGITAL PAYMENT SERVICE

(76) Inventor: William Grecia, Brooklyn, NY (US)

Correspondence Address: William Grecia, 932 east 79th street, Brooklyn, NY, 11236, US

(21) Appl. No.: 11/934,775

(22) Filed: Nov. 4, 2007

(51) Int. Cl. G06Q 40/00

(52) U.S. Cl. 705/40; 705/16; 705/39

(57) ABSTRACT

A system for point of sale payment processing for multiple recipients allowing division of funds to be distributed from a sum received from a buyer to multiple accounts simultaneously without a delay or manual action required from the administered member of the receiving benefactors.

### OTHER REFERENCES

“Progressive pay or Royalty pay” internet publication

http://www.pdncommunity.com/pdn/board/message?board.id=innovate&message.id=167&jump=true

### FIELD OF THE INVENTION

The invention presented in this document relates to the field of digital commerce systems used to send and receive financial payments using an internet gateway with control and operation from an electronic graphic user interface. The invention contained hereto also to the field of merchants and affiliates of physical and digital goods.

### BACKGROUND OF THE INVENTION

With the growing reliance of internet enabled financial services, merchants are required as a standard business practice to provide a way to accommodate their customers with the convenience of internet enabled retail systems for selling physical and digital goods. Internet payment systems also adds convenience to merchant relationships with employees, sales people, agents and affiliates who receive payments and wages based on a traditional commission model. A traditional commission model is defined as a payment structure where a percentage of a sale is paid to an associate. With a traditional commission payment model, an associate is usually paid weekly, monthly or yearly based on commissions earned. When using this payment model, many factors can explain the reason necessary for a delayed commission payment. Factors can include invoice payment terms, check clearance issues, cash on delivery, and delayed money payment terms such as try before you buy deals. The internet payment systems available today allow instant delivery of funds between internal accounts and interaction with brick and mortar banking institutions electronically. With such technological advances as 24 hour automated financial record keeping and logging, today's internet payment services limit a merchant from automatically paying commissions based on associate commitments with the convenience of payment division to multiple recipients during the point of sale of a internet payment transaction. Merchants are not able to take advantage of expansion opportunities for their business on internet platforms with associate relationships in the same manner they can accommodate their customers.

### SUMMARY OF INVENTION

With the rapid growth of internet commerce and distribution, a new system is needed to help merchants attract associates to sell their goods using a commission system that divides funds at the point of sale of a transaction. The internet provides a wide array of selling locations for digital goods such as social community websites, web logs, e-mail contacts, and message boards. With the availability of this system, merchants can open unlimited possibilities of digital distribution with eager associates on the internet around the world. Due to the fast pace of instant access of internet information and entertainment, potential associates interested in marketing, promoting, and selling digital goods are in need of a instantaneous method of compensation.

### DETAILED DISCRIPTION

The automated payment system described here explains how to divide a single payment made during a point of sale transaction to multiple recipients. There are many popular internet payment services such as PayPal, Google Checkout, E-gold, and 2Checkout. For this document, to define the internet payment service I will use the phrase “The Servic” and will only use a name of a service when relevant. The scenarios available to demonstrate the use and execution of this sytem are very diverse so I will explain a common situation and how this system processes the tasks. A five member music band signs up with The Service with each member creating an account and adding their financial information and completing all the verification requirements necessary. One member of the group is made responsible for administering the creation and management of the group code generated by The Service. For this document, to define the master account recipient I will use the phrase “The Master Recipient”. The Master Recipient creates a new product in The Service to accommodate multiple recipients. The Service generates a HTML code that is flagged for multiple payment recipients that is available for new recipient requests through a direct link embedded into the HTML code, a public access page on The Services' website, or an E-mail address embedded in the HTML code linking back to The Master Recipient for acceptance through his account control panel on The Service. Once a recipient makes a request for addition to the list of recipients of a code setup, The Master Recipient will need to manually approve or deny the request. If The Master Recipient approves the request, then The Service will update the html code reflecting the addition of a new recipient by adding account information and financial amount due at the point of sale. In this example once the other four members of the band request addition to the code, The Service generates the final code necessary for the band to use on the internet for such locations comprising of websites, web logs, social networking sites, E-mails, and message boards. An example of a HTML code structure used to execute internet payments is PayPal's buy now buttons. An example of PayPal's existing HTML code structure which do not allow payments to multiple recipients during a point of sale transaction is explained in this document available at PayPal's website:

<form name=“_xclick” action=“https://www.paypal.com/cgi-bin/webscr”
method=“post”>
<input type=“hidden” name=“cmd” value=“_xclick”>
<input type=“hidden” name=“business” value=“me@mybusiness.com”>
<input type=“hidden” name=“currency_code” value=“USD”>
<input type=“hidden” name=“item_name” value=“Teddy Bear”>
<input type=“hidden” name=“amount” value=“12.99”>
<input type=“image” src=“http://www.paypal.com/en_US/i/btn/x-click-
but01.gif” border=“0” name=“submit” alt=“Make payments with
PayPal - it's fast, free and secure!”>
</form>

Building on PayPal's HTML code structure, this is what the code would look like for a $30 USD transaction set for 3 recipients. The following example was originally written by the inventor on PayPal's development website on Nov. 3, 2006 in a posting named ”Progressive pay or Royalty pay”:

```
    <form action=“https://www.paypal.com/cgi-bin/webscr”
    method=“post”>
<input type=“hidden” name=“cmd” value=“_xclick”>
  <input type=“hidden” name=“business1”
value=username@paypalsplitpaymentsplease.com>
<input type=“hidden” name=“business2”
value=affiliate1@paypalsplitpaymentsplease.com>
<input type=“hidden” name=“business3”
value=affiliate2@paypalsplitpaymentsplease.com>
<input type=“hidden” name=“item_name” value=“Split Pay example”>
<input type=“hidden” name=“item_number” value=“Not Availible”>
<input type=“hidden” name=“amount1” value=“20.00”>
<input type=“hidden” name=“amount2” value=“5.00”>
<input type=“hidden” name=“amount3” value=“5.00”>
<input type=“hidden” name=“no_shipping” value=“2”>
<input type=“hidden” name=“no_note” value=“1”>
<input type=“hidden” name=“currency_code1” value=“USD”>
<input type=“hidden” name=“currency_code2” value=“USD”>
<input type=“hidden” name=“currency_code3” value=“USD”>
<input type=“hidden” name=“lc” value=“US”>
<input type=“hidden” name=“bn” value=“PP-BuyNowBF”>
  <input type=“image” src=“https://www.paypal.com/en_US/i/btn/x-
click-but23.gif” border=“0” name=“submit” alt=“Make payments
with PayPal - it's fast, free and secure!”>
  <img alt=“” border=“0” src=“https://www.paypal.com/en_US/i/scr/
pixel.gif” width=“1” height=“1”> </form>
```

Using the PayPal format for HTML code, multiple recipients and their payments are added in addition to the PayPal standard single entry structure for each field identified as “business1”, “amount1”, and “currency_code1”. The inventor expanded the HTML code to include two extra recipients to the HTML code to divide the $30 USD at the point of sale process. As shown in the HTML code example, adding a new entry to each field using an upwards sequence of the number count can progressively add more recipients to divide a sum, in this example this is represented by the values “business2”, “bussiness3”, “amount2”, “amount3”, “currency_code2”, and “curreny_code3”. When this code is processed by The Service during a point of sale, each value in the HTML code can be charged to the buyer individually or as a single payment with The Service dividing and distributing the sum due to each recipient by using an internal financial institution like infrastructure. With this system in operation each recipient receives their share of an agreed amount at the same time after a point of sale transaction occurs.

### BRIEF DISCRIPTION OF THE DRAWING

The drawing included in this document represent a flow chart describing the invention as shown:

FIG. 1 is a pictorial flow chart which explains the process of payment execution by a buyer to an internet payment service for a product or service, with the internet payment service processing the payment by the buyer for delivery to multiple recipients' simultaneously.

### DESCRIPTION OF THE PREFERRED EMBODIMENT

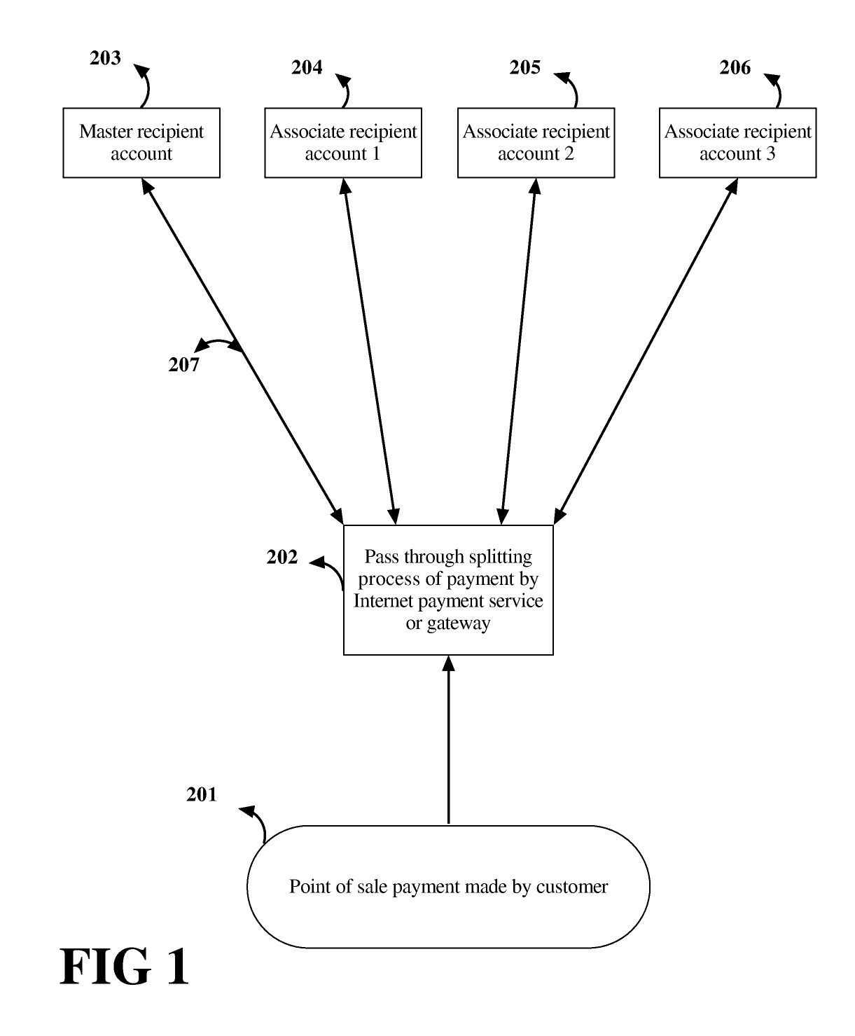

FIG. 1 Is a flow chart representing the process of dividing a payment made by a buyer to multiple recipients through a internet payment service:
(1) 201 represents the act of a buyer making a purchase to a internet payment service;
(2) 202 represents the internet payment service used in this system to accept payments from buyers and deliver divided payments of the funds collected simultaneously to multiple recipients according to agreed amounts;
(3) 203 represents the master recipient account holder who also acts as the administrator to approve and deny request for recipient additions to code generated by the internet payment service;
(4) 204 represents an added recipient for payment division for delivery from the internet payment service;
(5) 205 represents an added recipient for payment division for delivery from the internet payment service;
(6) 206 represents an added recipient for payment division for delivery from the internet payment service;
(7) 207 Represents communication between recipient accounts and the internet payment service to setup recipient groups for use with this system;

What is claimed is:

1. A point of sale payment system for simultaneous delivery of diverse financial amounts to multiple recipients.

2. The point of sale payment system of claim 1, wherein said system is processed by an internet payment processor for dividing and distributing funds to multiple recipients.

3. The automated point of sale payment system of claim 2, wherein the details of account information and financial division for the group of recipients sharing the process of this system are defined by a code.

4. The point of sale payment system of claim 2, wherein said system use a pass through method of delivering funds to multiple recipients with no delay after the necessary time needed to initiate the process of calculation and electronic delivery to the benefactors.

5. The automated point of sale payment system of claim 4, whereas the code structure is in an html internet language.
